(19) United States
(12) Patent Application Publication
(10) Pub. No.: US 2004/0101803 A1
(43) Pub. Date: May 27, 2004

(54) Reinforceable impression tray

(76) Inventors: Jack Tucker, San Antonio, TX (US); David Tucker, Houston, TX (US)

Correspondence Address: David A. Tucker, c/o Dr. Jack J. Tucker, 10306 Kings Grant Dr., San Antonio, TX, 78230, US

(21) Appl. No.: 10/705,593

(22) Filed: Nov. 10, 2003

Related U.S. Application Data
(62) Division of application No. 10/288,740, filed on Nov. 6, 2002.

(51) Int. Cl. A61C 9/00

(52) U.S. Cl. 433/38

(57) ABSTRACT

A dental impression tray that can be reinforced after the patient bites into the tray. In this particular embodiment, a joint in the tray's posterior is reinforced prior to intraoral placement by a removable wire running through hooks in the tray's rim. Removing the wire after the patient bites imparts flexibility to the joint, and then the tray's frame becomes rigid intraorally when an uncured immobilizing agent previously applied to the joint is cured or is self-cured. The tray's initial rigidity facilitates handling; its subsequent flexibility reduces the frame's plastic memory; and its subsequent rigidity durably locks the tray into a pressure-relieved position, reducing springback distortion.

### CROSS-REFERENCE TO RELATED APPLICATIONS

This application is a divisional and continuation-in-part of application Ser. No. 10/288,740, titled, “Variable Rigidity Impression Tray,” filed Aug. 27, 2002.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF INVENTION

1. Field of the Invention

This invention relates to dental impression trays and their method of use.

2. Description of the Related Art

Many dental and orthodontic procedures require the dentist to form an impression of the patient's teeth, either alone or in conjunction with the gums and vestibular anatomy. This impression typically is either used directly by the dentist or orthodontist to analyze the patient's mouth structure or is used to form a plaster replica of the patient's teeth, gums, and vestibule. Such impressions are typically used to produce dental replacement components and dental assemblies such as crowns, teeth, bridgework, dentures and other oral prostheses.

Dentists use trays to carry impression material to the mouth and to support the moldable material intraorally until it cures. The design of the tray depends on the size and shape of the area to be recorded. One type of dental impression tray—often referred to as a multiple impression tray, a dual arch tray, or a triple tray—is used to take impressions of both upper and lower portions of a patient's teeth and mouth and to provide concurrently an impression of the relative positions of the upper and lower teeth during a bite. It typically includes an upper trough and a bottom trough, each filled with impression material such as a setable material. The upper impression corresponds to an impression section of maxilla, the lower impression corresponds to a complimentary section of mandible, and the two complimentary impressions jointly provide an impression of the bite relationship of mandible to maxilla. In comparison to other impression-taking methods, using a dual arch tray is cheaper and faster.

Two kinds of dual arch trays are generally being marketed. One is metal with a disposable cloth or paper insert. These metal trays are expensive. They require cleaning and sterilization before reuse, which is inconvenient.

The other kind of dual arch tray is usually made of totally disposable materials such as plastic, paper, cloth, mesh, or a combination of these. The trays are inexpensive, which gives them the convenience of disposability. However, their flexibility and plastic memory can cause intraoral distortions in the impression.

In other words, the lack of complete rigidity in a tray can create a “springback” distortion transfer from the tray to the impression material on release of pressure to the tray sides, which is inadvertently applied by hard- and soft-tissue interferences at some point during the impression-making process. For example, pressure can be generated by the tongue, by occlusal forces pushing material against the tray wall, by the cheeks, or by tray impingement of gingival tissues, alveolar ridge, retromolar pad, tuberosity and teeth. This pressure flexes the tray while the impression material sets, causing inaccuracies in the impression when the distorted tray attempts to return to its original shape upon removal from the mouth. An impression in a flexible frame can also be distorted by forces applied to remove the tray from the patient's mouth or during routine laboratory handling. These inaccuracies are then transferred to the master cast when it is made in the dental laboratory. See U.S. Pat. No. 5,636,985 by Simmen, et al., dated Jun. 10, 1997; U.S. Pat. No. 5,513,985 by Robertson dated May 7, 1996.

The pressure of the tray against the gingiva or other soft tissues can also be uncomfortable to the patient. This discomfort can cause the patient to open or shift his bite while the impression material is setting, which can ruin the impression.

A tray for reducing springback distortion is described in U.S. Pat. No. 5,513,985 by Robertson dated May 7, 1996. The walls of this impression tray are joined by wires which allow movement of the walls during the taking of the impression and afterwards as the impression material is being cured or set. The impression material, once set, is said to maintain the shape of the wire due to the stronger memory of the impression material over the wire, which is weaker in memory. Likewise, Jones, R H, Jones N L and Hammond T W in the January 2001 issue of The Journal of the American Dental Association (Vol 132, p. 73) describe a method of weakening the tray's posterior bar prior to use by removing some plastic from a small section of it.

This alleged solution is merely a different kind of flexible tray—it strikes a different balance between rigidity and flexibility in the tray than that which is inherent to competing trays, and except for the reinforcement provided by the impression material, the tray's rigidity characteristics do not change. Like any flexible tray, it may distort upon removal from the mouth. Further, the tray's reinforcement is primarily provided by the cured impression material, which cannot be too supportive or else it will not be sufficiently rubbery to disengage from interproximal areas and other tooth structures. A cured impression held by a weak-framed tray is simply not sufficiently rigid to resist distorting forces. Even with the cured impression material reinforcing it, the tray is insufficiently rigid to withstand the rigors of ordinary laboratory handling, such as supporting the weight of dental stone when it has been poured into the impression. Further, this tray design relieves intraoral pressures in only the buccal-lingual direction. It is accepted wisdom in the dental industry that impression trays should be a rigid as possible.

Another technique for minimizing springback distortion is to fabricate a custom tray. See, e.g., U.S. Pat. No. 5,011,407 by Pelerin dated Apr. 30, 1991. Custom trays are well known in the art. They are time consuming, can be technique-sensitive, and use a significant quantity of expensive materials. Further they typically require a two-step process of forming the tray first into the anatomically correct shape inside the mouth and then removing it to take an ordinary impression. In a sense, custom trays are merely ordinary preformed trays manufactured by the dentist that have a lower likelihood of impinging tissues.

An unpublished U.S. patent application filed by Dr. Neal B. Gittleman on or about Oct. 23, 2003 shows a tray which uses light cured composite to reinforce the tray at a prepositioned joint. His application post-dates our parent patent filing, is mostly anticipated by and described within such filing, and directly derives from our attempt in early 2003 to co-market with Dr. Gittleman our tray technologies and his implant inventions to certain dental companies.

The springback distortion problem also inhibits the use of dual arch trays in implant dentistry. U.S. Pat. No. 6,508,650 by Gittleman issued Jan. 21, 2003 shows a low profile implant transfer post designed to be used with a dual arch tray. It is held in place by the impression material surrounding the transfer post, but impression material is rubbery and subject to the springback distortion forces transferred from an ordinary dual arch tray frame.

There is a need for a dual arch tray which is supportive during placement, which is subject to minimal springback distortion, and which is strong enough to help the impression withstand the stresses of removal from the mouth and routine laboratory handling.

### BRIEF SUMMARY OF THE INVENTION

The invention provides a dental impression tray that becomes more rigid after the patient has bitten into the impression material. The preferred embodiment is a dual arch impression tray having a bent support wire under tension that runs through several hooks arranged along the outside of the tray's frame. It has a joint in its frame, preferably in the posterior area, to which an immobilizing agent such as an uncured composite or adhesive has been applied. The support wire is pulled free immediately after the patient bites into the impression material, which allows the two parts of the frame separated by the joint to shift in response to biting forces, tissue impingement, and other intraoral forces—thereby relieving distortion-inducing stresses in the tray. The uncured material at the joint self-cures, or is light-cured, or is cured by the application of a chemical accelerant, shortly after the patient has bitten, which permits the impression to withstand removal stresses and routine laboratory handling with minimal distortion.

It is therefore an object of the present invention to provide an improved dental impression tray.

Another object of the invention is the provision of a dental impression tray having a frame design that relieves certain forces applied to it during impression-taking.

Another object of the invention is the provision of a dental impression tray which will minimize the springback distortions created by the memory found in plastics or metals traditionally used in impression trays that have one-piece frames.

Another object of the invention is the provision of a dental impression tray which is comfortable to the patient during impression-taking.

Another object of the invention is the provision of a dental impression tray which is flexible enough to yield to intraoral pressures yet can become strong enough to resist forces applied to its frame upon removing the tray from the mouth.

Another object of the invention is the provision of a dental impression tray which can withstand the rigors of rough laboratory handling.

Another object of the invention is the provision of a dental impression tray which has a thinner preformed posterior bar that minimizes interference with oral structures.

Another object of the invention is the provision of a preformed dual arch dental impression tray whose frame partially adapts itself to the patient's anatomy with no appreciable memory in the frame.

Another object of the invention is the provision of a custom-like dual arch dental impression tray that requires only small amounts of uncured material, thereby making it cost-effective to use expensive and highly engineered materials.

Another object of the invention is the provision of a dual arch dental impression tray that facilitates the use of more accurate dental impression materials which do not need to cure as hard as commonly-used impression materials.

Another object of the invention is the provision of a rigid dual arch dental impression tray that seats completely passively with little or no internal stress in the fame and which can therefore facilitate the integration of an implant transfer post directly with the tray's frame.

Another object of the invention is the provision of a dual arch dental impression tray that is accurate enough to use in implant dentistry.

Further objects and advantages of the invention will become apparent from a consideration of the drawings and ensuing description.

### BRIEF DESCRIPTION OF THE SEVERAL VIEWS OF THE DRAWING

Some of the features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a perspective view of a preferred embodiment of the tray.

FIG. 2 is a detail view of the tray's joint.

FIG. 3 is a detail view of one of the hooks on the tray's outside rim.

### DETAILED DESCRIPTION OF THE INVENTION

1. Design of Preferred Embodiment.

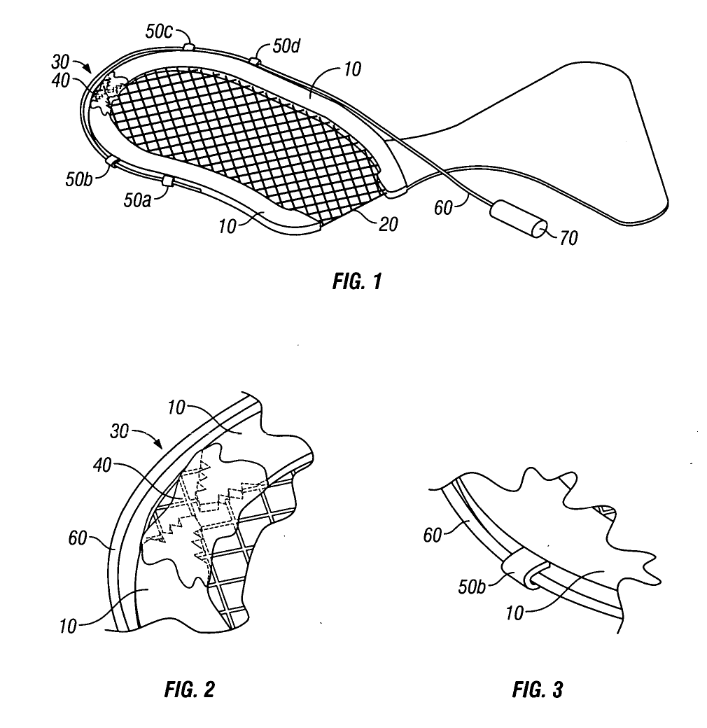

FIG. 1 shows a perspective view of the tray. In accordance with FIG. 1, the tray consists of: (a) a frame 10, preferably made of a rigid material such as plastic or metal, (b) a membrane 20 attached to or integral with the frame, which is preferably made of a close, thin, hydrophobic mesh netting (but which may also take the form of a paper, a sheet of plastic, filaments, gauze or other plastic or paper-like material), (c) a joint 30, which separates the frame into two sections that can move fairly independently, (d) an immobilizing agent 40, which is somewhat viscous and is packed through the membrane and encases the ends of the frame near the joint, (e) substantially identical hooks 50a, 50b, 50c, and 50d, which are curved projections that are integral with or attached to the frame, (e) a wire 60, which is preferably made of straight stainless steel rod which was recently bent into a curved shape, so as to pull the membrane taut and yet still retain the memory of the rod's previous shape, and which is sized to pass easily through the hooks, and (e) a grip 70, which is optional and is preferably a plastic-covered butt connector crimped onto the wire. For clarity, we show a low-walled tray, but the invention can also be embodied as a higher-walled tray. Likewise, we show a short posterior tray, but the invention also applies to trays of similar design having a longer frame that are suitable for taking an impression of anterior teeth and canine teeth.

2. Manner of Operation.

The tray is operated in the following manner. The user manually bends wire 60 from an initially straight shape in order to snap or thread it through hooks 50a, 50b, 50c, and 50d. An ordinary small-gauge stainless steel orthodontic wire has an acceptable combination of strength, smoothness, and ease of removal. The force provided by the memory in wire 60 reinforces the two sections of frame 10 so as to restrict their movement at joint 30 and so as to hold the membrane in a slightly tensioned state. This tension will later cause the membrane to provide support for the impression material as it is delivered to the mouth.

Then, the user applies an immobilizing agent 40 to joint 30 so that it encases the ends of the frame near joint 30 as well as the contiguous parts of mesh 20. Although a variety of materials will service, the immobilizing agent is preferably an uncured, mixed-two-part, self-curing dental composite. No immobilizing agent is ideal for all circumstances, however, so the user's selection of material should be guided by the following circumstances of the case: (i) expected time lag between material placement and intraoral insertion, (ii) speed of impression material cure, (iii) desired speed of dental composite cure, (iv) desired initial viscosity of the composite material, (v) anticipated ability of the patient to keep his tongue, cheek and jaw still, (vi) shrinkage during polymerization, (vii) biocompatibility, (viii) flavor, and (vii) cost.

The user then applies his preferred impression material to both sides of membrane 20 and delivers the impression-material-filled tray to the mouth. The patient bites, and the user visually verifies that the bite is satisfactory. The user then uses grip 70 to remove wire 60 from the tray and mouth with a smooth pull. The removal of wire 60 permits the two sections of frame 10 to shift at joint 30 in response to intraoral pressures applied to the frame, and immobilizing agent 40 should still be sufficiently viscous at this point to permit easy movement. If the user has previously cut the membrane at joint 30, this can permit the ends of the frame to move independently in nearly every direction—especially in the buccal-lingual direction. Ideally, as soon as practicable after the intraoral pressure is relieved, immobilizing agent 40 should self-cure or be light-cured by the user to a rigidity sufficient to immobilize the two sections of frame 10. The user removes the impression and tray from the mouth once the impression material and immobilizing agent 40 have cured sufficiently.

3. Alternative Embodiments

The preferred embodiment of the invention described above is one of many possible ones. Clearly, the tray does not need a removable reinforcement means (e.g., the wire and hooks design shown in the preferred embodiment); however, including a removable reinforcement means allows the tray designer to provide a highly flexible joint that enhances the mobility of the joint and tray walls. Further, even the indicated joint is dispensable. The entire posterior bar could serve the same function if it were sufficiently flexible to move readily in response to forces placed on the tray during impression-taking.

Alternatively, that flexibility function may not need to be served. A traditional posterior bar that is not designed for flexibility could be used, so long as the resistence provided by the immobilizing agent was sufficient to reduce any springback distortion that would otherwise be communicated by tension in the tray's frame and mesh. In other words, a nonjointed, inflexible design that permits tension to remain in the frame is permissible if that tension can be reduced to clinical insignificance (by restricting the flexing of the tray back to its original position).

As further explained below, the posterior bar could be locked into position, even if the frame was bearing a distorting load, by curing an immobilizing agent within or without the curved posterior bar—preferably along its entire length of curve. In a tray made of flexible plastic, this design would be superior to curing immobilizing agent only around a joint, since any distorting load placed on the tray when pouring up the model or removing it from the mouth would normally be transferred to the sections of the posterior bar that are adjacent to the immobilizing agent at the cured joint. Of course, the preferred tray would be rigid enough to be supportive during placement, then be flexible enough to relieve intraoral stress during use, and then become rigid again prior to removal to the mouth.

3a. Immobilizing Agent Selection

There are many ways to design a joint and immobilizing agent that will impart rigidity to a tray after the patient bites. The design and composition of the joint, of course, depends upon the means by which it is to be immobilized. For example, although a dental composite is preferred for its strength, viscosity, rapid curing, FDA approval, ease of handling, and similar factors, the immobilizing agent could also be an adhesive or gap-filling, resin-like material such as epoxy, cyanoacrylate, acrylic, two-part acrylic, two-step acrylic, silicone, polyurethane, retaining compound, low-temperature thermoplastic, threadlocking compound, thermoplastic polymer, thermosetting polymer, glue, composite filler, resin, wood filler, a thermosetting rubber unsuitable for use as an impression material, or a similar substance. Any adhesive or other material that undergoes a transition from a deformable state to a rigid, solid state could be a suitable candidate. Of course, once a curable immobilizing agent is finally, fully and irreversibly cured, it should no longer be properly considered to be an immobilizing agent within the meaning of this discussion.

Ideally, this transition should occur after the patient bites into the tray and before the tray is removed from the mouth, but it would be acceptable for the cure to begin or continue outside this time range—so long as the cure provides sufficient support to help control clinically significant springback upon removal from the mouth. Further curing after the tray is removed from the mouth is desirable because it helps the tray withstand rough laboratory handling.

In addition to the factors cited above, some other factors that should guide the selection of an immobilizing agent include biocompatibility, time of cure, tendency to adhere to tooth enamel or oral tissue, strength of cure, gap-filling capability, adhesive substrate, cost, availability of accelerators and adhesion promoters, ease of use, initial viscosity, outgassing characteristics, taste, storage methods, toxicity, smell, shelf life, preferred joint design, and pot life.

The immobilizing agent selected could act to immobilize the frame's separate sections in different ways. It could adhere them together, locking them in an encasing, hard substance, interfere with the action of a joint, or act by some combination of these methods. In a non-jointed design which permits the posterior bar to bear a significant load, the cured or adhesive material should physically block tray's posterior bar from flexing back toward its original position under the load. Further, depending upon the kind of immobilizing agent selected, it could be self-curing, light-curing, dual curing, accelerant-curing, catalyst-curing, evaporative-curing, heat-curing, or moisture-curing. Depending upon the tray's design and the method of cure, the immobilizing agent could be pre-applied to the joint or tray frame at the factory; or added immediately prior to use; or applied after the patient bites.

3b. Joint Design

There are many ways to design a joint that will permit the frame sections to move in response to intraoral forces. The preferred embodiment describes the joint as an open, mesh-filled gap between the frame's two sections, but it could also be one or more traditional joints having a more limited range of motion—such as a prismatic joint (e.g., a key-and-keyhole joint), rotational joint (e.g., a hinge, a ball-and-socket joint, looped rings, thread-and-nut joint), or elastic joint (e.g., the two sections of frame bridged by a flexible material, or a sponge-like material soaked in immobilizing agent, or an immobilizing-agent-filled tube, or a void). To permit movement in the buccal-lingual direction (which would allow the ends of the frame to spread apart or cross each other), the joint could even be made to be accordion-like, chain-like, or in the form of one or more rings looped into each other (e.g., Olympic rings).

As used in this application, the term “joint” is defined to also include a gap or separation in the frame. Such a gap could be created by cutting the posterior bar and perhaps some of the mesh; but if the immobilizing agent and posterior bar thickness permit it, then preferably the gap should be arranged to cause the two sections of posterior bar to overlap each other. Consider a posterior bar formed in two sections from two overlapping arcs, with each having only one terminus in its respective tray wall. After the impression material cures around this “overlapping arcs” joint design, the impression material would inhibit the flexing of the joint by inhibiting movement of the tip of each arc by distributing the load placed on the impression material—whereas a ball-and-socket type joint would primarily stress the impression material at a single point near the joint. For purposes of this application, the term “joint” should also be understood to include a section or the entirety of the posterior bar, provided it is intended to flex to relieve distorting forces. Although the preferred embodiment describes a single joint at the apex of the posterior bar, the joint could be varied in number, position and orientation so as to relieve stress from various locations and directions.

The immobilizing means could also be provided by deforming the joint so as to interfere with its function. For example, if the joint were to be comprised of a hollow aluminum ball-and-socket joint, the user could use an instrument to crush the socket with the ball inside, either during or after the patient's bite or during a trial bite, thereby preventing the joint's action. In this embodiment, the joint should be shifted to the buccal side of the frame's posterior so it is reachable with minimal disturbance to the patient's bite.

3c. Thermoplastic designs.

The user or factory could fill or encase the joint or posterior bar in thermoplastic or a similar substance which would harden when cooled to intraoral temperatures. Low-temperature thermoplastics are commonly used in dentistry. They are typically heated by immersing them in boiling water. Typically they are engineered to become highly deformable at about 140 to 180 degrees Fahrenheit, but for purposes of this application they could be engineered differently. For example, it could be less deformable so as to minimize drift or separation from the joint. Or, if the hot thermoplastic either (i) will not directly contact tissues (because it is shielded by the exterior surface of the posterior bar or tray) or (ii) will be heated in only a very small area, then a higher temperature thermoplastic could be used. As used in this application, the polymerization of plastic will be deemed to be a kind of “cure.”

Unlike conventional uses to which dental thermoplastics are put, in this application the thermoplastic only needs to be hot/deformable enough to permit a limited range of motion of the joint or tray posterior bar before it locks the frame into the adjusted position. Stated differently, it only needs to become plasticized enough when heated (and in a small enough area) so that its subsequent cooled shape can better correspond to the stressed or altered position of the tray, thereby reducing the internal stresses within the tray frame. In other words, so long the plastic partially or fully polymerizes while the tray's frame is in its stressed or joint-altered position, springback distortion is reduced. The thermoplastic can act by being a structural component of the posterior bar, by encasing the joint in the posterior bar, or by physically blocking the operation of the joint in the posterior bar.

Many different designs of thermoplastic trays are possible. One has a hollow tube running through or along the handle, through or along the buccal wall, around the posterior bar (or comprising the posterior bar), and through or along the lingual wall. The user would simply inject hot thermoplastic so that it fills the tube and allow it to cool. This injection could occur before impression material is applied to the tray or, assuming the posterior part of the tube is designed to be unobstructed when strained, after the patient bites into the tray.

Alternatively, all or part of the posterior bar could be made from thermoplastic. The user would heat the thermoplastic prior to use with a heat gun, a glue gun, warm water, microwave energy, exothermically-reacting chemicals, a flame, an internally-imbedded resister wired to an electric current, or a special-purpose heating element preferably designed to clamp onto the posterior bar. The heating means could directly warm the plastic, or it could act indirectly by heating an object engaged with the tray, such as a copper or aluminum rod internal to the tray that preferentially projects from the handle.

An advantage to heating the thermoplastic chemically, electrically or with a heat-transmissive structure after the tray is inserted in the mouth is that the thermoplastic provides structural support to the tray while it is being manipulated outside the mouth, yet it permits the joint to function while the impression material is curing in the mouth. Of course, if the thermoplastic is to be heated intraorally by one of these means, or is to be hotter than normal, then the heat-generating or heat-communicating or current-carrying structure means should be thermally and electrically insulated from oral tissues either by the plastic of the tray itself or by something else. Thermoplastic can be applied by the user by manually packing it around the joint or posterior bar, or it can be applied as a component, structural part of the posterior bar by the manufacturer.

There are many ways to integrate or apply the thermoplastic to the tray. The posterior bar could have an internal thermoplastic core or an external thermoplastic shell surrounding a normal plastic core. The low-temperature thermoplastic could be intermixed with ordinary plastic so as to form a kind of composite, or the thermoplastic could be engaged with the ordinary plastic in rings, much like disc cartilage engages the bones in the human spine. Further, it could simply be packed around or within the joint so as to immobilize it when it cures.

3d. Trays having a Self-Curing Immobilizing Agent

Much of the preceding discussion applies to self-curing immobilizing agents used to reinforce the tray. The self-curing material could be applied through a small-diameter tube integral with or affixed to the tray that runs through its entire frame; or at minimum through the flexible part of its posterior bar. The cure process can begin before the tray is inserted in the mouth and continue after its removal from the mouth. The immobilizing agent can be integrated with the tray as per the other methods mentioned for thermoplastic. The material could be packed around the joint, applied within the joint, or could simply be contained or injected through a tube running through the tray's frame and/or posterior bar. If a two-part or mixed immobilizing material is to be injected through the tube, then the tube could contain internal baffles like a mixing tips' so as to obviate the need for the dentist to use an ordinary mixing tip.

The embodiment of the self-curing tray having a tube running through the tray merits discussion. The tube in which the immobilizing agent is contained could be sealed at both ends and perhaps be pressurized with inert gas. The immobilizing agent within (e.g., wood filler, epoxy, or superglue) would be curable upon exposure to ordinary air or moisture or by the evaporation of a solvent mixed into the agent. Cutting the portion of the tube projecting from the buccal wall out of the mouth (or from the handle) would expose the agent, commencing the cure. To aid the penetration of air or moisture to the adhesive throughout the tube, or to allow the solvent to evaporate from all areas, the tube could contain a filler such as a granulated, reinforcing material (e.g., composite filler, glass particles, metal particles, or any other particle to which the adhesive will bind). Alternatively, a catalyst or adhesive could be inserted into such a tube, wherein the tube contains granulated particles or not.

One substance that should work particularly well in this design is an anaerobic threadlocking adhesive dripped or injected into a tube that contains metal grains or wires. These threadlocking adhesives are made in “wicking” formulations that aid the penetration of the adhesive by capillary action. The multiple steel wires (whether woven into a cable or not) that are contained within the tube could lock into a fixed position when the threadlocker, superglue or other low-viscosity adhesive cures.

3e. Trays having a Light Curable Immobilizing Agent.

The Gittleman patent application describes one design of light curable tray, but many embodiments are possible. For example, the joint can be moved toward the buccal side of the frame and be cured: (i) by shining a curing light through an appropriately-shaped reflective tube (e.g., a fiber optic cable or curing light attachment) designed to point toward the joint when intraorally inserted either through or alongside the tray wall or (ii) by shining a curing light through a light-transmissive tray frame.

This tube can be separate from the tray or, if cost considerations permit, integral with it. If the hollow tube or fiber optic cable is integral with the tray and posterior bar, then the placement of the joint at the buccal side of the posterior bar is not critical. The joint can remain at the apex of the curved posterior bar or even be located beyond it, since light trapped within an internally reflective tube like a fiber optic cable can change direction to reach the light curable immobilizing agent at the joint. If a large mass of light curable composite surrounds the joint, then the composite itself could be made with reflective components in it that would help to scatter the light where needed. Likewise, if a composite layer surrounds the fiber optic strands in any place, then reflective or light-reorienting components (e.g., aluminum dust, tiny glitter, cracks in the glass fibers, glass chips cured within the fiber optic glass) mixed in with the fiber optic glass in that region can scatter the light as needed.

But perhaps the better alternative for a light curable tray is to have a tube running through the frame of the tray that is filled with a light curable composite. As with the self-curing tray described above, the fiber optic tube should ideally extend beyond the joint and/or posterior bar so as to immobilize the entire posterior bar, or immobilize the posterior bar and tray walls together. To facilitate light propagation, the composite should be made as clear to curing light as practicable—perhaps being as simple as powdered or granulated fiber optic glass soaked in a clear, light curable adhesive. This tube would be surrounded by (or would surround) a membrane or coating of metal, plastic or another substance that reflects curing light. Alternatively, the plastic of the tray itself could be made a color that reflects curing light (e.g., blue or ultraviolet), so that no tube or a simple clear tube would be all that is required. In that event, the composite could simply be injected or preapplied through a channel in the tray. Further, the impression material used with the tray could be engineered to reflect curing light, which may obviate the need for any light containment system around the posterior bar.

The Gittleman application cites a clear conic “light funnel” to direct the curing light into the smaller diameter optical fiber assembly, but a better design than a simple reflective funnel is possible. To concentrate and directionalize the light, the curing light attachment should have one or more lenses within it that concentrate and narrow the light beam. If necessary, additional lenses at the end of the attachment would orient the light exiting the attachment in approximately parallel lines. This attachment would be easy to design by one skiiled in the appropriate arts.

Another embodiment would be as follows. The tray's posterior bar has a tube filled with a light curable composite. An impression material transparent to light (or an inexpensive other material transparent to light) is applied around the posterior bar. The impression material of choice is applied to the area of clinical interest and other parts of the tray. The patient bites; and the impression materials cure. The dentist causes the patient's teeth to open out of the opposing arch—then light cures the posterior bar through the light transmissive material. Alternatively, the impression is removed and then the dentist cures the posterior bar through the light transmissive material. In this technique, the force of gravity may distort an extremely weak frame, so it may be necessary to overcome that force by suspending the impression in a fluid before light curing through the fluid.

3f. “Nonjointed” Designs.

As discussed above, the invention can be implemented without a structure that looks like an ordinary joint. The posterior bar could simply be internally braced by light-curing or self-curing immobilizing agents within it. As discussed above, the tray could have wires or cabled wire within a tube that is integral with and/or affixed to the frame. Alternatively, the memory in the bar could be defeated simply by heating thermoplastic components of the tray in or around the posterior bar.

This invention can even be implemented with an ordinary dual arch tray if the user encased all or a part of the posterior bar in an immobilizing agent which would not disturb the patient's bite. In this embodiment, the immobilizing agent should preferably be one that adheres to the plastic, metal, or other material on the surface of the posterior bar.

3g. Implant-Compatible Designs

The fact that the invention produces a tray that adapts itself to the mouth without springback tension and then becomes extremely rigid makes possible another advance. The dentist can use a low-profile implant post similar to the one shown in the Gittleman patent application—but which can become attached to the dual arch tray frame. Affixing the implant transfer post to the tray's frame has the advantage of bracing the impression material exactly where accuracy is the most important—near the surfaces of the proximal and occluding teeth that will adjoin the restoration. The transfer post would have a buccally-directed projection, perhaps integrated with the buccal wing or perhaps replacing it, that is below the height of the occlusal plane. The projection is positioned and adapted to be affixable to the tray's frame.

For example, the projection could pass through or close to an opening in the tray wall. To ensure a reasonably precise orientation of the tray's opening with the projection, the dentist would either have to carefully choose a tray with an opening that is appropriately pre-positioned in the right spot; or she would have to try the tray in the mouth so she can cut away or enlarge an appropriately placed opening. This opening should be in the shape of a slit wide enough to accommodate some minor movement of the tray frame during biting with impression material. The opening would be designed to simply drop over the projection without interference.

The tray is loaded with impression material and placed in the mouth so it fits over the projection. The patient bites, and the dentist inspects to ensure that the tray's frame is not pressing onto the projection. The dentist would wipe away any impression material oozing from the opening in the buccal tray wall and apply a putty-like immobilizing agent that engages both retentive features on the projection and retentive features on the tray's frame. The immobilizing agent's cure will affix the projection to the tray's frame.

The loss of impression material through the temporary opening in the tray wall should not be problematic (since the transfer post is mainly braced by the tray's frame and not simply by the impression material), but if it is perceived to be problematic there is an easy fix. The dentist would simply inject replacement impression material back into the void through the opening before locking the transfer post to the frame. Alternatively, the dentist could simply allow the oozing material to cure, then remove the oozed material from the projection and any other places where it interferes, and then affix the projection to the tray with immobilizing agent before removing the tray from the mouth. This process of affixing the projection to the tray's frame would be difficult to do without disturbing the patient's bite, so perhaps the putty-like immobilizing agent could be preapplied before the dentist inserts the tray into the mouth. Clinical testing may show that the impression material surrounding the transfer post is sufficiently rigid to permit the affixing of the projection to the tray frame to be done outside the mouth, after the impression is removed from the mouth.

Thus, the reader will see that the devices and methods described above provide a means for imparting flexibility and rigidity when needed in a dual arch impression tray. Its pre-impression rigidity facilitates handling, while its flexibility during impression-taking minimizes springback distortion, while its post-cure rigidity minimizes the risk of distortions induced by impression removal and laboratory handling.

While various embodiments of the present invention have been shown and described above, it should be understood that they have been presented by way of example only, and not limitation. Many other variations are possible. It will be obvious to those skilled in the art that changes and modifications may be made without departing from the spirit of this invention in its broader aspects. Thus, the breadth and scope of the present invention should not be limited by any of the above described exemplary embodiments. The aim in the appended claims is to cover all such changes and modifications as fall within the true spirit and scope of this invention.

What is claimed is:

1. A tray for taking a dental impression comprising:
a frame having a generally “U”-shaped portion, wherein the bottom part of the “U”-shaped portion comprises a posterior bar;
a membrane supported on and integral with said frame and spanning said “U”-shaped portion;
a means for imparting a rigidity to the tray which is additive to the rigidity imparted by an impression material to be used to take the impression, whereby such additive rigidity primarily takes effect after the patient has bitten into the impression material, wherein such means for imparting rigidity to the tray comprises an object engaged with the frame in the tray's posterior region.

2. The tray of claim 1 wherein the object comprises an immobilizing agent other than the impression material to be used to take the impression.

3. The tray of claim 2 wherein the immobilizing agent is applied to the frame of the tray and is suitably positioned and compositioned so that when cured, such immobilizing agent would impede the frame's alteration of shape.

4. The tray of claim 3 wherein the frame further comprises a joint in its posterior and wherein the immobilizing agent is suitably positioned and compositioned to impede the relative movement of the sections of the frame bridged by the joint when cured.

5. The tray of claim 2 wherein the frame further comprises a tube affixed to the frame or a channel within the frame that contains the immobilizing agent.

6. The tray of claim 5 wherein the tube or channel contains internal mixing baffles through which the immobilizing agent can be passed.

7. The tray of claim 2 wherein the frame further comprises a fiber optic glass.

8. The tray of claim 2 wherein the immobilizing agent comprises a material that is readily deformable when uncured but difficult to deform when cured.

9. The tray of claim 2 wherein the immobilizing agent comprises an adhesive.

10. The tray of claim 2 wherein the immobilizing agent comprises a composite.

11. The tray of claim 2 wherein the immobilizing agent comprises an acrylic.

12. The tray of claim 2 wherein the immobilizing agent comprises a plastic.

13. The tray of claim 12 wherein the plastic comprises a heated thermoplastic which will harden as it cools from mouth-tolerable temperatures to body temperature.

14. The tray of claim 12 wherein the object comprises a thermosetting plastic.

15. The tray of claim 1 wherein the frame further comprises a means for affixing the frame to an implant transfer post.

16. The tray of claim 15 wherein the buccal wall is affixed to the implant transfer post by a support member which connects the implant transfer post to the buccal wall of the frame.

17. The tray of claim 2 wherein the material comprising the frame is a color that reflects curing light.

18. A tray for taking a dental impression comprising:
a frame having a generally “U”-shaped portion;
a membrane supported on and integral with said frame and spanning said “U”-shaped portion; and
a curable or self-curing immobilizing agent that is uncured, wherein such immobilizing agent is not the impression material to be used to take the impression.

19. A tray for taking a dental impression comprising:
a frame comprising a generally “U”-shaped portion, wherein the bottom part of the “U”-shaped portion comprises a posterior bar;
a membrane supported on and integral with said frame and spanning said “U”-shaped portion; and
an uncured composite applied to the frame's posterior bar.
